(19) United States
(12) Patent Application Publication
(10) Pub. No.: US 2006/0001963 A1
(43) Pub. Date: Jan. 5, 2006

(54) Fresnel lens sheet and rear projection screen provided with it

(75) Inventor: Hiroyuki Ishikawa, Shinjuku-Ku (JP)

Correspondence Address: PARKHURST & WENDEL, L.L.P., 1421 PRINCE STREET, SUITE 210, ALEXANDRIA, VA, 22314-2805, US

(73) Assignee: Dai Nippon Printing Co., Ltd., Toyko-To (JP)

(21) Appl. No.: 10/527,166

(22) PCT Filed: Jan. 22, 2004
(86) PCT No.: PCT/JP04/00531

§ 371 Date: Mar. 9, 2005

(30) Foreign Application Priority Data
Jan. 22, 2003 (JP) 2003-14012

(51) Int. Cl. G03B 21/56; G03B 21/60

(52) U.S. Cl. 359/457; 359/460

(57) ABSTRACT

The invention provides a Fresnel lens sheet, in which a rainbow, hot band, moiré, color corn and the like are inconspicuous, bright uniformity is maintained, sharpness of an image is not deteriorated, and a balance is kept, and provides a rear projection type screen having the Fresnel lens sheet. In the Fresnel lens sheet 1 having a Fresnel lens element group 4 each Fresnel lens element composed of a Fresnel lens surface 2 and a non-lens surface 3 on a surface (light outgoing surface 7) thereof, the surface roughness of at least one of the Fresnel lens surface 2 of the Fresnel lens element group, the non-lens surface 3 of the Fresnel lens element groups 4, and the sheet surface 12, on which no Fresnel lens element group 4 is formed, is made rougher from the central portion of the Fresnel lens sheet outwardly. At the time, it is preferable that the difference between the surface roughness of the central portion of the Fresnel lens sheet 1 and the surface roughness of the outer peripheral portion of the Fresnel lens sheet be 0.1 μm or more to 5.0 μm or less.

### TECHNICAL FIELD

The present invention relates to a Fresnel lens sheet including a prism-shaped Fresnel lens element group and to a rear projection type screen having the same.

### BACKGROUND ART

A rear projection type projection television uses a transmission type screen having a Fresnel lens sheet including a Fresnel lens surface formed on a viewing side.

FIG. 10 shows a sectional view showing an example of a conventional Fresnel lens sheet. As shown in FIG. 10, the conventional Fresnel lens sheet 101 has such a structure that a plurality of prism-shaped Fresnel lens elements 104 each composed of a Fresnel lens surface 102 and a non-lens surface 103 are formed on the sheet surface on a viewing side (in FIG. 10, a light outgoing surface 107) in an annular shape.

When incident light 105 is incident on the Fresnel lens sheet 101 from a light source (not shown) as an image projector, the incident light 105 passes through a light incident surface 106 and the light outgoing surface 107 of the Fresnel lens sheet 101 and outgoes to the viewing side as image light 108.

At the time, when a part of the light having passed through the light incident surface 106 of the Fresnel lens sheet 101 is reflected on the light outgoing surface 107, it may become stray light 110 such as flare light and the like, as shown in FIG. 10. Note that the stray light 110 occurs in a mode shown in FIG. 9, in addition to the mode shown in FIG. 10.

As shown in FIGS. 9 and 10, the stray light 110 occurring in the Fresnel lens sheet 101 outgoes to the viewing side from the non-lens surfaces 103 of the Fresnel lens elements 104 and from the ridge portions 109 between the non-lens surfaces 103 and the Fresnel lens surfaces 102 thereof. In particular, when a rear projection type screen having the Fresnel lens sheet 101 is viewed from thereabove, rainbow-shaped unnecessary light 111 is viewed on the lower portion of the rear projection type screen. The unnecessary light 111 is called a “rainbow” and tends to occur particularly strongly in the peripheral portion of the Fresnel lens sheet 101 in which a Fresnel lens angle is increased. In FIG. 9, reference numeral 111 (dotted lines) shows occurrence of the rainbow, and reference numeral 111 (solid line) shows occurrence of color corn.

To solve the above problem, there are conventionally proposed: a method of forming a light diffusion surface (rough surface) on, for example, non-lens surfaces of Fresnel lens elements (refer to, for example, patent document 1 (Japanese Utility Model Application Laid-Open Publication No. 63-187139); a method of regulating the roughness of rough surfaces formed on non-lens surfaces of Fresnel lens elements (refer to, for example, patent document 2 (Japanese Patent Application Laid-Open Publication No. 4-127101); a method of making non-lens surfaces, which are located in portions other than the central portion of a Fresnel lens sheet, rough (refer to, for example, patent document 3 (Japanese Patent Application Laid-Open Publication No. 8-36103); and a method of making one or both of a light incident surface side and an light outgoing surface side of a Fresnel lens sheet uniformly rough (refer to, for example, patent document 4 (Japanese Patent Application Laid-Open Publication No. 5-127257). According to these methods, an amount of the unnecessary outgoing light 111 is reduced by diffusing the stray light 110 described above, thereby the rainbow and the like are made inconspicuous.

Incidentally, the rear projection type screen described above has such requirements that: (1) brightness is uniform (hereinafter, referred to as “bright uniformity”); (2) a hot band, moiré, color corn and the like are inconspicuous; and (3) an image can be viewed sharply, and the like, in addition to that the unnecessary light such as the rainbow and the like is made inconspicuous, so that a viewer can view an image without an uncomfortable feeling. Thus, there is required a rear projection type screen in which the above conditions are coordinated in a balanced manner.

Although the Fresnel lens sheets disclosed in patent documents 1 to 4 have a certain effect in that the rainbow is made inconspicuous by reducing stray light, they cannot sufficiently improve bight uniformity (uniformity of brightness). Further, in the Fresnel lens sheet disclosed in patent document 4, since Fresnel lens surfaces and light incident surfaces are also made uniformly rough in addition to non-lens surfaces, there is also a possibility that the sharpness of an image is deteriorated.

### DISCLOSURE OF THE INVENTION

An object of the present invention, which has been made in view of the above points, is to provide a Fresnel lens sheet, in which a rainbow, hot band, moiré, color corn and the like are inconspicuous, bright uniformity is maintained, sharpness of an image is not deteriorated, and a balance is kept, and to provide a rear projection type screen having the Fresnel lens sheet.

To achieve the above object, a Fresnel lens sheet having a Fresnel lens element group, each Fresnel lens element being composed of a Fresnel lens surface and a non-lens surface on a surface thereof is characterized in that the surface roughness of at least one of the Fresnel lens surface of the Fresnel lens element group, the non-lens surface of the Fresnel lens element group, and the sheet surface, on which no Fresnel lens element group is formed, of the Fresnel lens sheet is made rougher from the central portion of the Fresnel lens sheet outwardly.

According to the present invention, since the surface roughness of at least one surface constituting the Fresnel lens sheet is made gradually rougher from the central portion toward the outer peripheral portion thereof, a portion nearer to the outer peripheral portion having a larger surface roughness can more effectively diffuse stray light. As a result, occurrence of unnecessary light such as a rainbow, color cone and the like which mainly appears in the outer peripheral portion can be suppressed. Further, occurrence of moiré, which is produced between the Fresnel lens sheet and a lenticular lens sheet, or is produced by the Fresnel lens element group and a lens formed on the rear surface of the Fresnel lens element group and having a diffusion property in a vertical direction, can be reduced. Furthermore, since the surface roughness of the central portion of the Fresnel lens sheet is smaller than that of the outer peripheral portion thereof, there is also an effect in that the sharpness of the central portion of a rear projection type screen, to which the Fresnel lens sheet is assembled, can be secured.

In the Fresnel lens sheet of the present invention, when the distance from the central portion of the Fresnel lens sheet is shown by x(mm), it is preferable that the amount of change (dRa(x)/dx) of the surface roughness (Ra(x)(μm)) satisfy 0<dRa(x)/dx<1.0 in the surface roughness at any position.

With the above arrangement, the sharpness of an image can be changed without giving an uncomfortable feeling to a viewer, thereby the bright uniformity can be maintained.

Further, in the Fresnel lens sheet of the present invention, the difference (ΔRa) between the surface roughness of the central portion of the Fresnel lens sheet and the surface roughness of the outer peripheral portion of the Fresnel lens sheet is preferably 0.1 μm or more to 5.0 μm or less.

With the above arrangement, occurrence of unnecessary light such as the rainbow, color corn and the like mainly appearing in the outer peripheral portion and occurrence of moiré can be suppressed, thereby the sharpness of the central portion of a rear projection type screen can be maintained within the range in which the bright uniformity of the rear projection type screen, to which the Fresnel lens is assembled, can be maintained.

Further, in the Fresnel lens sheet of the present invention, a specific mode of the change of the surface roughness is preferably any one of: a mode (1) in which the surface roughness is made rougher continuously or stepwise from the central portion of the Fresnel lens outwardly in a radial direction; a mode (2) in which the surface roughness is made rougher continuously or stepwise from the central portion of the Fresnel lens outwardly in a vertical direction; and a mode (3) in which the surface roughness is made rougher continuously or stepwise from the central portion of the Fresnel lens outwardly in a horizontal direction.

Various phenomena based on the unnecessary light can be effectively improved by specifying the direction of change of the surface roughness. Specifically, for example, the mode (1) is particularly preferable to improve the rainbow, hot band, color corn, and moiré. The mode (2) is particularly preferable to improve the hot band, rainbow, color corn, and moiré. The mode (3) is particularly preferable to improve the rainbow, color corn, and moiré.

Further, in the Fresnel lens sheet of the present invention, a lens sheet for diffusing incident light in a vertical direction may be formed on the surface of the Fresnel lens sheet on which no Fresnel lens element group is formed.

Note that the rear projection type screen of the present invention is characterized in that it is provided with the Fresnel lens sheet of the present invention and the lenticular lens sheet for diffusing the light having passed through the Fresnel lens sheet.

### BRIEF DESCRIPTION OF THE DRAWINGS

FIG. 1 is a sectional view showing a Fresnel lens sheet according to an embodiment of the present invention;

FIG. 2 is a perspective view showing a modification of the Fresnel lens sheet shown in FIG. 1;

FIG. 3 is a plan view showing an example of a mode of change of a surface roughness of the Fresnel lens sheet according to the embodiment of the present invention (mode in which surface roughness changes radially);

FIG. 4 is a plan view showing another example of the mode of change of the surface roughness of the Fresnel lens sheet according to the embodiment of the present invention (mode in which surface roughness changes in a vertical direction);

FIG. 5 is a plan view showing still another example of the mode of change of the surface roughness of the Fresnel lens sheet of the embodiment of the present invention (mode in which surface roughness changes in a horizontal direction);

FIGS. 6A to 6F are views explaining modes in which the surface roughness of the Fresnel lens sheet according to the embodiment of the present invention changes continuously or stepwise (mode in which the surface roughness changes from a central portion toward an outer peripheral portion);

FIG. 7 is a process view explaining an example of a method of adjusting the surface roughness of the Fresnel lens sheet according to the embodiment of the present invention;

FIG. 8 is a perspective view showing an example of a rear projection type screen having the Fresnel lens sheet according to the embodiment of the present invention;

FIG. 9 is a view showing an example of a stray light path in a Fresnel lens sheet; and

FIG. 10 is a sectional view showing an example of a conventional Fresnel lens sheet.

### MODES FOR CARRYING OUT THE INVENTION

A Fresnel lens sheet and a rear projection type screen having the same according to an embodiment of the present invention will be explained below with reference to the drawings.

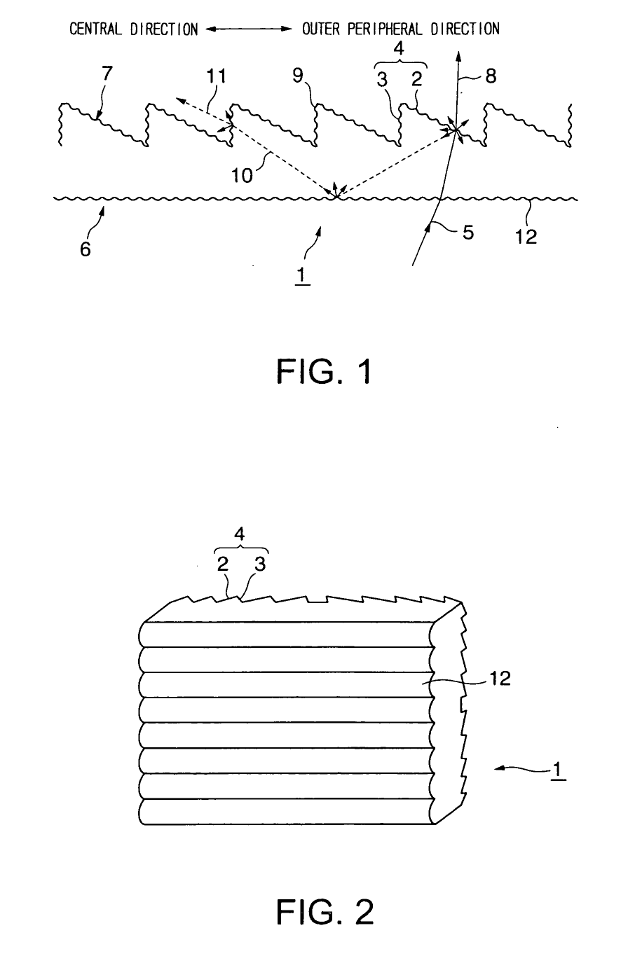

FIG. 1 is a sectional view showing the Fresnel lens sheet according to the embodiment of the present invention. As shown in FIG. 1, the Fresnel lens sheet 1 according to the embodiment has a Fresnel lens element group 4 formed on one surface (light outgoing surface 7) thereof, each Fresnel lens element of the Fresnel lens element group 4 being composed of a Fresnel lens surface 2 and a non-lens surface 3. When incident light 5 is incident on the Fresnel lens sheet 1 from a light source (not shown) as an image projector, the incident light 5 passes through a light incident surface 6 and a light outgoing surface 7 of the Fresnel lens sheet 1 and is caused to outgo to a viewing side as image light 8. In the Fresnel lens sheet shown in FIG. 1, the surface roughness of art least one surface of the Fresnel lens surfaces 2 of the Fresnel lens element group 4, the non-lens surfaces 3 of the Fresnel lens element group 4, and a sheet surface 12 on which no Fresnel lens element group 4 is formed is made rougher continuously or stepwise from the central portion of the Fresnel lens sheet outwardly.

In the Fresnel lens sheet shown in FIG. 1, the sheet surface 12, on which the Fresnel lens element groups 4 are not formed, is a flat surface. However, a lens shape for diffusing the incident light 5 in a vertical direction may be formed on the sheet surface 12 on which the Fresnel lens element group 4 is not formed, as shown in FIG. 2.

In the description, the “central portion” of the Fresnel lens sheet 1 is defined as a central point of the Fresnel lens sheet 1 or as a definite region including the central point, and the surface roughness of the central point or in the definite region including the central point is compared with the surface roughness of the respective portions including the outer peripheral portion of the Fresnel lens sheet 1. Although the definite region described here is not particularly limited and is prescribed in consideration of entire bright uniformity, it includes even a region having a distance of about 100 mm from the central point. The “outer peripheral portion” of the Fresnel lens sheet 1 indicates a portion, where the surface roughness thereof changes continuously or stepwise, in the vicinity of the periphery (four sides) of the Fresnel lens sheet 1.

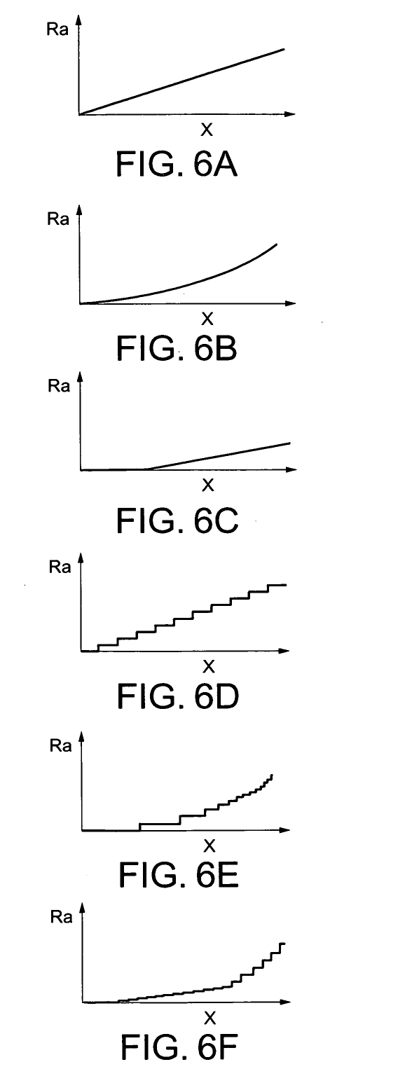

In the embodiment, the surface roughness of the Fresnel lens sheet 1 is made rougher continuously or stepwise from the central point thereof outwardly. The term “continuously” used here has the same meaning as a mode in which there is no region having the same surface roughness and the surface roughness changes straight as shown in FIGS. 6A to 6C (in the description, “straight” has the same meaning as “linearly” and is used as a concept including a curve). Further, the term “stepwise” indicates a mode in which a plurality of regions each having a definite surface roughness exist individually and the surface roughness of the regions increase stepwise as shown in FIGS. 6D and 6E. At the time, the mode in which the surface roughness changes continuously and the mode in which the surface roughness changes stepwise may be combined with each other on the same sheet surface as shown in FIG. 6F. Further, the surface roughness may continuously change on the sheet surface (light outgoing surface 7) on which the Fresnel lens element group 4 each Fresnel lens element being composed of the Fresnel lens surface 2 and the non-lens surface 3 are formed and may change stepwise on the sheet surface 12 on which the Fresnel lens element group 4 is not formed, and vise versa. However, when the distance from the central portion of the Fresnel lens sheet 1 is shown by x(mm), the amount of change (dRa(x)/dx) of the surface roughness Ra(x)(μm) of at least one of the Fresnel lens surface 2 of the Fresnel lens element group 4, the non-lens surface 3 of the Fresnel lens element group 4, and the sheet surface 12 on which no Fresnel lens element group 4 is formed is preferably 0<dRa(x)/dx<1.0. This is because when the surface roughness is increased abruptly, a difference of sharpness of an image is conspicuous and an uncomfortable feeling is given to a viewer.

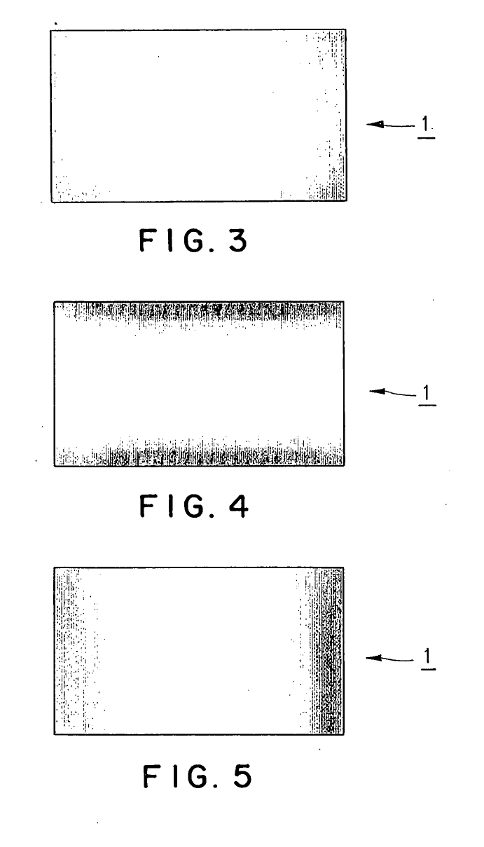

Further, in the embodiment, the surface roughness of the Fresnel lens sheet 1 may be changed continuously or stepwise in a radial direction (refer to FIG. 3), in a vertical direction (refer to FIG. 4), or in a horizontal direction (refer to FIG. 5).

The mode in which “the surface roughness is changed continuously or stepwise in the radial direction” is such a mode that the surface roughness at the positions having the same distance (radius) from the central portion is the same or approximate the same, and the surface roughness is made rougher continuously or stepwise as the radius increases. The mode, in which “the surface roughness is changed continuously or stepwise in the vertical direction (up/down direction when viewed in a plane, and so forth)” is such a mode that the surface roughness in the horizontal direction (right/left direction when viewed in a plane, and so forth) is the same or approximate the same, and the surface roughness is made rougher continuously or stepwise from the central portion outwardly in the vertical direction. The mode, in which “the surface roughness is changed continuously or stepwise in the horizontal direction is such a mode that the surface roughness in the vertical direction is the same or approximate the same, and the surface roughness is made rougher continuously or stepwise from the central portion outwardly in the horizontal direction.

Further, as a preferable mode of the embodiment, the difference (ΔRa) between the surface roughness (Ra1) of the central portion of the Fresnel lens sheet 1 and the surface roughness (Ra2) of the outer peripheral portion thereof is preferably 0.1 μm or more to 5.0 μm or less. When the difference between the surface roughness of the central portion and that of the outer peripheral portion is within the above range, occurrence of unnecessary light such as a rainbow, color corn and the like and occurrence of moiré, which mainly appear in an outer peripheral portion, can be suppressed, as well as the bright uniformity can be maintained in the entire screen. Further, the sharpness can be secured in the central portion of the screen.

When the difference of the surface roughness is less than 0.1 μm, the occurrence of the unnecessary light such as the rainbow, the color corn, and the like cannot be sufficiently suppressed while maintaining the sharpness of an image in the central portion. In contrast, when the surface roughness exceeds 5.0 μm, there is a possibility that the bright uniformity or the sharpness of an image is deteriorated.

Note that the “surface roughness” referred to in the description is based on JIS B 0601-1994 and is evaluated by the average value of the surface roughness obtained by averaging the surface roughness (Ra) of a center line whose measuring length is set to 0.1 mm, when the surface roughness is measured at 10 positions having the same distance x(mm) from the central portion. The surface roughness can be measured by an ordinary used surface roughness measuring instrument.

When the surface roughness is changed continuously or stepwise in the radial direction as shown in FIG. 3, the problem of a rainbow, hot band, color corn, moiré and the like can be effectively solved. When the surface roughness is changed continuously or stepwise in the vertical direction as shown in FIG. 4, the problem of the hot band, rainbow, color corn, moiré and the like can be effectively solved. Further, when the surface roughness is changed continuously or stepwise in the horizontal direction as shown in FIG. 5, the problem of the rainbow, color corn, moiréand the like can be effectively solved.

Although the surface roughness is preferably changed continuously or stepwise on at least one of the Fresnel lens surface 2 of the Fresnel lens element group 4, the non-lens surface 3 of the Fresnel lens element group 4, and the sheet surface 12 on which the Fresnel lens element group 4 is not formed in the Fresnel lens sheet 1, it is particularly preferable to change the surface roughness on the non-lens surface 3 of the Fresnel lens element group 4 and on the sheet surface 12 on which no Fresnel lens element group 4 is formed. This is because, first, stray light 10 is often reflected on the sheet surface 12 on which no Fresnel lens element group 4 is formed. This is because, second, unnecessary light 11 outgoing to the viewer side can be effectively reduced by scattering the stray light 10 on the non-lens surface 3 of the Fresnel lens element group 4.

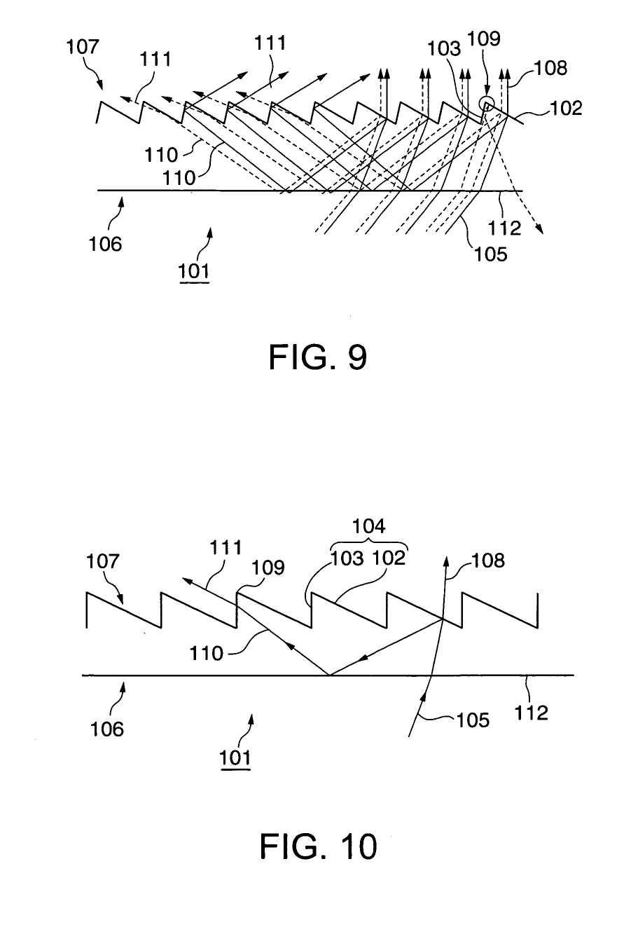

Note that, in the conventional Fresnel lens sheet 101, a part of the incident light 105 incident on the light incident surface 106 of the Fresnel lens sheet 101 from the light source (not shown) as the image projector is reflected on the Fresnel lens surfaces 102 and made to the stray light 110 which is further reflected on the light incident surface 106, outgoes from the Fresnel lens surfaces 102 and from the non-lens surfaces 103, and is made to the unnecessary light 111 as shown in FIGS. 9 and 10. In contrast, in the Fresnel lens sheet 1 according to the embodiment, at least one of the Fresnel lens surface 2 of the Fresnel lens element group 4, the non-lens surface 3 of the Fresnel lens element group 4, and the sheet surface 12 (light incident surface 6) on which no Fresnel lens element group 4 is formed is gradually made rougher from the central portion toward the outer peripheral portion. Accordingly, the unnecessary light 11, which outgoes from the non-lens surfaces 3 of the Fresnel lens element group 4 and from the ridge portions 9 between the non-lens surfaces 3 and the Fresnel lens surfaces 2, is reduced by diffusing the stray light 10, thereby occurrence of the rainbow, color corn and the like can be very effectively reduced. In particular, in the embodiment, since the surface roughness is made rougher continuously or stepwise, there is also an effect that a blurred image and the sharpness of an image are not impaired in the central portion of the Fresnel lens sheet 1, and the bright uniformity of a rear projection type screen, to which the Fresnel lens sheet 1 is assembled, can be maintained in its entirety.

A method of adjusting the surface roughness of the respective surfaces (the Fresnel lens surface 2 of the Fresnel lens element group 4, the non-lens surface 3 of the Fresnel lens element group 4, and the sheet surface 12 on which no Fresnel lens element group 4 is formed) of the Fresnel lens sheet 1 will be explained.

The respective surfaces of the Fresnel lens sheet 1 can be adjusted to a desired surface roughness by: (1) subjecting the surface of the Fresnel lens sheet 1 to a matt processing when it is molded; (2) subjecting the surface of a metal mold for molding a Fresnel lens to the matt processing; (3) subjecting the surface of a resin sheet (Fresnel lens base member) from which a Fresnel lens is molded to the matt processing; or (4) subjecting a metal mold for molding a resin sheet, from which the Fresnel lens is molded, to the matt processing.

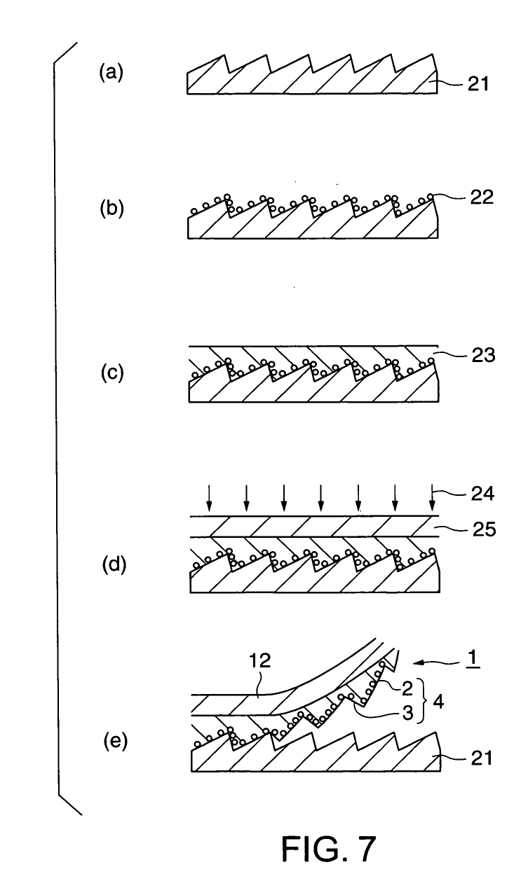

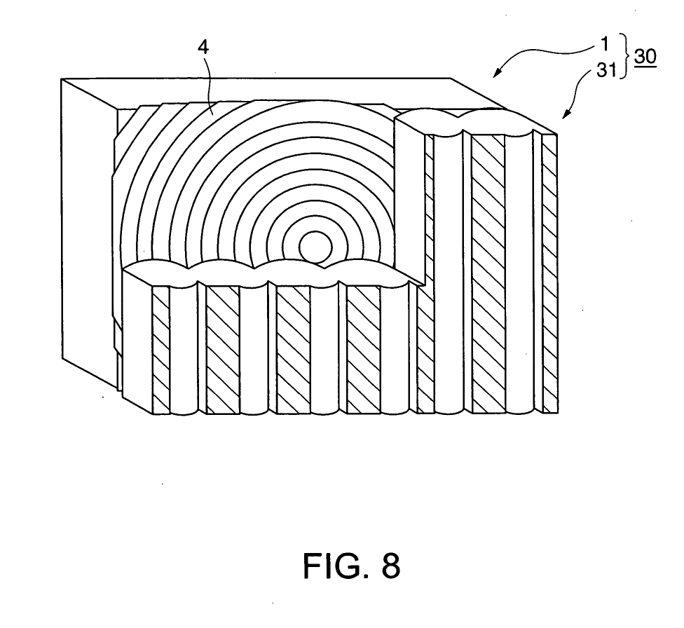

As shown in FIG. 7, in the method (1) (method of subjecting the surface of the Fresnel lens sheet 1 to the matt processing when it is molded), when, for example, the Fresnel lens sheet 1 is molded, beads 22 and the like are sprayed on the surface of a metal mold 21 (refer to FIGS. 7 (a) and 7(b)), and a UV resin 23 is flown to the metal mold 21 on which the beads 22 and the like are sprayed (refer to FIG. 7(c)). After a resin sheet 25 is placed on the UV resin 23, the UV resin 23 is cured by irradiating ultraviolet rays (UV) 24 thereto (refer to FIG. 7(d)), and the Fresnel lens sheet 1 having been subjected to the curing treatment is peeled from the metal mold 21 (refer to FIG. 7(e)), thereby the surface of the Fresnel lens sheet 1 can be subjected to the matt processing. Note that glass beads, styrene beads and the like can be exemplified as the additive material such as the beads 22 and the like dispersed on the surface of the metal mold 21.

In the Fresnel lens sheet 1 formed by the method (1), the beads 22 and the like can be provided with a continuous density gradient on the Fresnel lens surface 2 and the non-lens surface 3 of the Fresnel lens element group 4, thereby the surface roughness of these surfaces can be continuously changed. In the method, the difference between the surface roughness of the central portion of the Fresnel lens sheet 1 and that of the outer peripheral portion thereof can be set within the range described above by controlling the particle size and the amount of spray of the beads. Specifically, the amount of spray of the beads is preferably changed in respective portions. Exemplified as a special spray method of changing the amount of spray of the beads in the respective portions is a method of changing the number of opening and closing of a sprayer for spraying the beads depending on a portion where the beads are sprayed, and the like.

Note that, the above method (1) can be easily applied to any of: a case, in which the surface roughness is made rougher continuously or stepwise from the central portion outwardly in the radial direction; a case, in which the surface roughness is made rougher continuously or stepwise from the central portion outwardly in the vertical direction; and a case, in which the surface roughness is made rougher continuously or stepwise from the central portion outwardly in the horizontal direction.

As the method (2) (method of subjecting the surface of the Fresnel lens molding metal mold to the matt processing), there are exemplified: (i) a method of cutting the shape of Fresnel lens elements on a surface of a metal mold and subjecting the thus cut surface of the metal mold to a blast processing; and (ii) a method of adjusting an electrolytic casting condition when the metal mold is manufactured, and the like. With these methods, the surface roughness of the cut surface of the metal mold can be changed continuously or stepwise from the surface of the metal mold for forming the central portion of the Fresnel lens sheet 1 toward the surface of the metal mold for forming the outer peripheral portion of the Fresnel lens sheet 1. As a result, since the surface roughness of the metal mold is transferred onto the surface of the Fresnel lens sheet molded by the metal mold, it is possible to change the surface roughness of the Fresnel lens sheet continuously or stepwise from the central portion thereof to the outer peripheral portion thereof.

As a specific blast processing method of changing the surface roughness of the Fresnel lens forming metal mold continuously or stepwise, there are exemplified a method of starting a blast treatment from the outer peripheral portion of the metal mold and reducing the pressure of a spray nozzle toward the central portion of the metal mold, and the like. Note that glass beads and the like, which are ordinarily used to metal, are preferably used as particles (shots) used in the blast processing.

Further, as the method of changing the surface roughness of the metal mold continuously or stepwise by adjusting the electrolytic casting condition, there are exemplified a method of disposing a shield plate so that a plating liquid flows from the outer peripheral portion of the metal mold toward the central portion thereof in matt plating, and the like. With the above method, since the outer peripheral portion of the Fresnel lens sheet 1 is more plated than the central portion thereof, the matt plating is executed by making fine crystal grains formed on the surface of the metal mold larger and rougher toward the outer peripheral portion, thereby the surface roughness of the metal mold can be continuously changed. The method of manufacturing the metal mold by the electrolytic casting is preferably applied when the surface roughness of the Fresnel lens sheet 1 is continuously changed.

The method (2) of forming the Fresnel lens sheet 1 can be preferably applied when the surface, on which the Fresnel lens element group 4 molded by the metal mold is formed (that is, the Fresnel lens surface 2 and the non-lens surface 3), of the Fresnel lens sheet 1 is provided with a desired surface roughness. In this method, the difference between the surface roughness of the central portion of the Fresnel lens sheet 1 and that of the outer peripheral portion thereof can be set within the range described above by controlling the pressure of the spray nozzle in the blast processing. Specifically, the pressure of the spray nozzle is preferable set to 1 to 5 kgf/cm². In contrast, when the difference is set within the range by adjusting the electrolytic casting condition, the condition can be adjusted by changing the convecting condition of the plating liquid or by interposing an appropriate shield plate between electrodes.

Further, when the Fresnel lens sheet 1 is formed by the metal mold, since a flat surface (refer to FIG. 1) or a lens shape (refer to FIG. 2), for diffusing incident light in the vertical direction, is formed also on the sheet surface 12 on which no Fresnel lens element group 4 is formed, the surface roughness of the sheet surface 12 can be controlled by a method similar to that described above. As a result, the surface roughness of any of the Fresnel lens surface 2 of the Fresnel lens element group 4, the non-lens surface 3 of the Fresnel lens element group 4, and the sheet surface 12 on which no Fresnel lens element group 4 is formed can be changed continuously or stepwise.

Note that, the above method (2) can be easily applied to any of: a case, in which the surface roughness is made rougher continuously or stepwise from the central portion outwardly in the radial direction; a case, in which the surface roughness is made rougher continuously or stepwise from the central portion outwardly in the vertical direction; and a case, in which the surface roughness is made rougher continuously or stepwise from the central portion outwardly in the horizontal direction. Since this method is a method of transferring the shape of the surface of the metal mold, it is particularly preferably applied to large-scale production.

In the method (3), when the Fresnel lens is formed on the resin sheet using the UV resin, an effect similar that described above can be obtained by subjecting the surface of the resin sheet opposite to that on which the Fresnel lens is formed (that is, the sheet surface 12 on which no Fresnel lens element group 4 is formed) to the matt treatment. A method similar to the method (1) is preferably used as the matt treatment method.

In the method (4), a matt-treated surface can be formed on the metal mold for molding the resin sheet on which the Fresnel lens is to be molded by a method similar to the method (2). As a result, the matt-treated surface can be also transferred onto the resin sheet. This method is particularly preferable when the resin sheet is produced in large quantities.

In the methods (3) and (4), any of the Fresnel lens molded surface of the resin sheet and the surface thereof opposite to the Fresnel lens molded surface (that is, the surface on which no Fresnel lens element group is molded) may be used as the matt-treated surface. However, the surface of the resin sheet opposite to the Fresnel lens molded surface is advantageously used as the matt-treated surface in production.

The Fresnel lens sheet 1 according to the embodiment can be used by being assembled in a rear projection type screen 30 as shown in FIG. 8. The rear projection type screen 30 shown in FIG. 8 includes a lenticular lens sheet 31 assembled therein together with the Fresnel lens sheet 1, the lenticular lens sheet 31 diffusing the light having passed through the Fresnel lens sheet 1. In the rear projection type screen 30, the lenticular lens sheet 31 is used to enlarge a viewing angle. The Fresnel lens sheet 1 can be used in combination with various types of sheets such as a protection sheet for protecting the rear projection type screen 30, a designed front sheet, and the like, in addition to the lenticular lens sheet 31 described above. The structure and the type of the lenticular lens sheet and the structure, the type, and the like of the front sheet are not particularly limited, and conventionally used various types of sheets can be combined with each other. As a result, there can be provided a rear projection type screen in which the rainbow, hot band, moiré, color corn, and the like are not conspicuous and which can maintain the bright uniformity and does not deteriorate the sharpness of an image. That is, there can be provided a well-balanced rear projection type screen through which a viewer can view an image in a wide angle without an uncomfortable feeling.

### EXAMPLES

Specific examples of the present invention will be explained below together with comparative examples. In the following embodiments and comparative examples, surface roughness is measured with VK-8510 of KEYENCE. Further, at the time, the resolution in a depth direction was 0.01 μm.

### Example 1

After a Fresnel lens shape was cut on a brass sheet for a metal mold at a pitch of 0.112 mm, a surface of the brass sheet was subjected to matt Ni plating using a shield plate. An infinite number of columnar Ni plated particles were formed on the lens surfaces and the non-lens surfaces of the metal mold, and the roughness of the particles increased toward the outer peripheral portion of the metal mold. A Fresnel lens was molded by applying a UV resin using the metal mold obtained as described above. The resultant Fresnel lens sheet had a width of 1084 mm and a height of 821 mm. In the Fresnel lens sheet, the surface roughness of the lens surfaces and the surface roughness of the non-lens surfaces were made rougher from the central portion (surface roughness: about 0.05 μm) of the Fresnel lens sheet outwardly toward the outer periphery thereof in a radial direction (surface roughness: about 0.45 μm). When the difference (ΔRa) between the surface roughness of the central portion of the Fresnel lens sheet and that of the outer peripheral portion thereof was measured, it was 0.4 μm. Further, the amounts of change of the surface roughness (dRa(x)/dx) of respective portions were 0.0001<dRa(x)/dx<0.002.

### Example 2

A resin sheet, from which a Fresnel lens sheet was molded, was extrusion molded. At the time, a mirror roll was employed as a metal mold roll for forming the light incident side of the resin sheet, and the surface of the mirror roll was Cu plated and then subjected to a blast treatment. The blast treatment was executed by spraying glass beads to the roll from the outer peripheral portion thereof at a spray pressure of 2 kgf/cm², gradually reducing the spray pressure toward the central portion of the roll and setting the spray pressure to 0.5 kgf/cm² in the central portion. When the glass beads were sprayed from the central portion to the outer peripheral portion, the spray pressure was gradually increased and set to 2 kgf/cm² in the outer peripheral portion. The resin sheet was molded by the metal mold obtained as described above, and a Fresnel lens was molded using a UV resin on the surface of the resin sheet opposite to the matt-treated surface thereof. The resin sheet was cut such that the direction in which the matt treatment changed was in coincidence with the height direction (vertical direction) of the Fresnel lens. The resultant Fresnel lens sheet was a sheet whose mode was such that the surface roughness of the surface, on which no Fresnel lens element was formed, changed continuously from the central portion thereof outwardly in a vertical direction. The Fresnel lens sheet had a width of 1084 mm and height of 821 mm, the surface roughness thereof was 0.4 μm in the central portion thereof and 3.2 μm in the outer peripheral portion thereof in the vertical direction, and ΔRa was 2.8 μm. Further, the amounts of change of the surface roughness (dRa(x)/dx) of respective portions in the vertical direction were 0.12<dRa(x)/dx<0.70.

### Example 3

A resin sheet, from which a Fresnel lens sheet was molded, was extrusion molded. At the time, a mirror roll was employed as a metal mold roll for forming a light incident side of the resin sheet, and the surface of the mirror roll was Cu plated and then subjected to a blast treatment. The blast treatment was executed by spraying glass beads to the roll from the outer peripheral portion thereof at a spray pressure of 2 kgf/cm², gradually reducing the spray pressure toward the central portion of the roll and setting the spray pressure to 0.5 kgf/cm² in the central portion. When the glass beads were sprayed from the central portion to the outer peripheral portion, the spray pressure was gradually increased and set to 2 kgf/cm² in the outer peripheral portion. The resin sheet was molded by the metal mold obtained as described above, and a Fresnel lens was molded using a UV resin on the surface of the resin sheet opposite to the matt-treated surface thereof. The resin sheet was cut such that the direction in which the matt treatment changed was in coincidence with the width direction (horizontal direction) of the Fresnel lens. The resultant Fresnel lens sheet was a sheet whose mode was such that the surface roughness of the surface, on which no Fresnel lens element was formed, changed continuously from the central portion thereof outwardly in a horizontal direction. The Fresnel lens sheet had a width of 1084 mm and height of 821 mm, the surface roughness thereof was 0.4 μm in the central portion thereof and 2.6 μm in the outer peripheral portion thereof in the horizontal direction, and ΔRa was 2.2 μm. Further, the amounts of change of the surface roughness (dRa(x)/dx) of respective portions in the horizontal direction were 0.12<dRa(x)/dx<0.70.

### Example 4

A resin sheet, from which a Fresnel lens sheet was molded, was extrusion molded. At the time, after lenses having a vertical diffusion property were formed on a metal mold roll for forming the light incident side of the resin sheet at a pitch of 0.1 mm, the surface of the roll was Cu plated and then subjected to a blast treatment. The blast treatment was executed by spraying glass beads to the roll from the outer peripheral portion thereof at a spray pressure of 2 kgf/cm², gradually reducing the spray pressure toward the central portion of the roll and setting the spray pressure to 0.5 kgf/cm² in the central portion. When the glass beads were sprayed from the central portion to the outer peripheral portion, the spray pressure was gradually increased and set to 2 kgf/cm² in the outer peripheral portion. The resin sheet was molded by the metal mold obtained as described above, and a Fresnel lens was molded using a UV resin on the surface of the resin sheet opposite to the lens-molded surface thereof. The resultant Fresnel lens sheet was a sheet whose mode was such that the surface roughness of the surface, on which no Fresnel lens element was formed, changed continuously from the central portion thereof outwardly in a vertical direction. The Fresnel lens sheet had a width of 1084 mm and a height of 821 mm, the surface roughness of the Fresnel lens sheet was 0.3 μm in the central portion thereof and 3 μm in the outer peripheral portion thereof, and ΔRa was 2.7 μm. Further, the amounts of change of the surface roughness (dRa(x)/dx) of respective portions in the vertical direction were 0.01<dRa(x)/dx<0.90.

### Comparative Example 1

After a Fresnel lens shape was cut on a brass sheet for a metal mold at a pitch of 0.112 mm, a surface of the brass sheet was subjected to glossy Ni plating. A Fresnel lens was molded by applying a UV resin and by molding the UV resin using the resultant metal mold. The resultant Fresnel lens sheet had a width of 1084 mm and a height of 821 mm. The lens surfaces and the non-lens surfaces of the Fresnel lens sheet were composed of uniformly flat surfaces (surface roughness Ra: about 0.1 μm), and the surface roughness (Ra) of the Fresnel lens sheet did not almost change radially outwardly from the central portion to the outer peripheral portion thereof. When the difference (ΔRa) between the surface roughness of the central portion of the Fresnel lens sheet and that of the outer peripheral portion thereof was measured, it was 0.05 μm. Further, the amounts of change of the surface roughness (dRa(x)/dx) of respective portions were dRa(x)/dx [symbol] 0.

### Comparative Example 2

After a Fresnel lens shape was cut on a brass sheet for a metal mold at a pitch of 0.112 mm, a surface of the brass sheet was subjected to Cu plating and then subjected to a blast treatment. The blast treatment was executed under the condition of spraying glass beads at a spray pressure of 4 kgf/cm². A Fresnel lens was molded by applying a UV resin and by molding the UV resin using the resultant metal mold. Although the lens surfaces and the non-lens surfaces of the resultant Fresnel lens sheet were composed of uniformly rough surfaces (surface roughness Ra: about 3 μm), the surface roughness of the Fresnel lens sheet did not almost change from the central portion to the outer peripheral portion thereof. When the difference (ΔRa) between the surface roughness of the central portion of the Fresnel lens sheet and that of the outer peripheral portion thereof was measured, it was 0.05 μm. Further, the amounts of change of the surface roughness (dRa(x)/dx) of respective portions were dRa(x)/dx [symbol] 0.

### Comparative Example 3

After a Fresnel lens shape was cut on a brass sheet for a metal mold at a pitch of 0.112 mm, a surface of the brass sheet was subjected to a blast treatment. The blast treatment was executed under a condition of shielding the brass sheet within the range of a diameter of 10 cm from the center thereof and spraying glass beads at a spray pressure of 4 kgf/cm². A Fresnel lens was molded by applying a UV resin and by molding the UV resin using the resultant metal mold. Although the lens surfaces and the non-lens surfaces within the shielded range of the resultant Fresnel lens sheet were composed of flat surfaces (surface roughness Ra: about 0.05 μm), the surface, which was not shielded, of the Fresnel lens sheet was composed a rough surface (surface roughness Ra: about 4.05 μm). When the difference (ΔRa) between the surface roughness of the central portion of the Fresnel lens sheet and that of the outer peripheral portion thereof was measured, it was 4.0 μm. Further, the amounts of change of the surface roughness (dRa(x)/dx) of respective portions were 0.01<dRa(x)/dx<3.3.

### Comparative Example 4

After a Fresnel lens shape was cut on a brass sheet for a metal mold at a pitch of 0.112 mm, a surface of the brass sheet was subjected to a blast treatment. The blast treatment was executed under a condition of spraying glass beads at a spray pressure of 4 kgf/cm² and started from the outer peripheral portion of the brass sheet while gradually reducing the spray pressure. The spray pressure was set to 0.1 kgf/cm² at the central portion of the brass sheet. A Fresnel lens was molded by applying a UV resin and by molding the UV resin using the resultant metal mold. Although the lens surfaces and the non-lens surfaces of the resultant Fresnel lens sheet were composed of flat surfaces (surface roughness Ra: about 0.10 μm), the surface of the outer peripheral portion of the Fresnel lens sheet was composed a rough surface (surface roughness Ra: about 5.35 μm). When the difference (ΔRa) between the surface roughness of the central portion of the Fresnel lens sheet and that of the outer peripheral portion thereof was measured, it was 5.25 μm. Further, the amounts of change of the surface roughness (dRa(x)/dx) of respective portions were 0.01<dRa(x)/dx<2.0.

(Result of Evaluation)

Rear projection type screens were made by combining the Fresnel lens sheets according to the embodiments 1 to 4 and the comparative examples 1 to 4 with a lenticular lenses having a pitch of 0.52 mm and set to rear projection type display apparatuses for comparison. In the rear projection type screens using the Fresnel lens sheets of the embodiments 1 to 4, a rainbow, moiré, and hot band were reduced and the bright uniformity of an image was also improved.

TABLE 1

| | | | | | Blurring | |
|---|---|---|---|---|---|---|
| | | Color | Hot | | at | Bright |
| | Rainbow | corn | band | Moiré | center | uniformity |
| Embodiment | ◯ | ◯ | ◯ | ◯ | ⊚ | Good |
| 1 | | | | | | |
| Embodiment | ◯ | ◯ | ◯ | Δ | ◯ | Good |
| 2 | | | | | | |
| Embodiment | ◯ | ◯ | Δ | ⊚ | ◯ | Good |
| 3 | | | | | | |
| Embodiment | ◯ | ◯ | ⊚ | Δ | ◯ | Good |
| 4 | | | | | | |
| Comparative | X | X | X | X | ⊚ | Edge of |
| example 1 | | | | | | product is |
| | | | | | | dark |
| Comparative | ◯ | ◯ | X | ◯ | X | Edge of |
| example 2 | | | | | | product is |
| | | | | | | dark |
| Comparative | ⊚ | ◯ | X | ⊚ | ⊚ | Difference |
| example 3 | | | | | | between |
| | | | | | | center and |
| | | | | | | edge of |
| | | | | | | product is |
| | | | | | | conspicuous |
| Comparative | ⊚ | ⊚ | ◯ | ◯ | ⊚ | Blurring in |
| example 4 | | | | | | image at |
| | | | | | | edge of |
| | | | | | | product is |
| | | | | | | felt uneasy |
| | | | | | | and edge of |
| | | | | | | product is |
| | | | | | | dark |

Evaluation:
⊚: Effective,
◯: Somewhat effective,
Δ: Not adversely affected,
X: Ineffective

1. A Fresnel lens sheet having a Fresnel lens element group, each Fresnel lens element being composed of a Fresnel lens surface and a non-lens surface on a surface thereof, characterized in that a surface roughness of at least one of the Fresnel lens surface of the Fresnel lens element group, the non-lens surface of the Fresnel lens element group, and a sheet surface, on which no Fresnel lens element group is formed, of the Fresnel lens sheet is made rougher from the central portion of the Fresnel lens sheet outwardly.

2. A Fresnel lens sheet according to claim 1, characterized in that when a distance from the central portion of the Fresnel lens sheet is shown by x(mm), an amount of change (dRa(x)/dx) of the surface roughness Ra (x) (μm) of at least one of the Fresnel lens surface of the Fresnel lens element group, the non-lens surface of the Fresnel lens element group, and the sheet surface on which no Fresnel lens element group is formed is preferably 0<dRa(x)/dx<1.0.

3. A Fresnel lens sheet according to claim 1, characterized in that the difference (ΔRa) between the surface roughness of the central portion of the Fresnel lens sheet and the surface roughness of the outer peripheral portion of the Fresnel lens sheet is 0.1 μm or more to 5.0 μm or less.

4. A Fresnel lens sheet according to claim 1, characterized in that the surface roughness is made rougher continuously or stepwise from the central portion of the Fresnel lens sheet outwardly in a radial direction.

5. A Fresnel lens sheet according to claim 1, characterized in that the surface roughness is made rougher continuously or stepwise from the central portion of the Fresnel lens sheet outwardly in a vertical direction.

6. A Fresnel lens sheet according to claim 1, characterized in that the surface roughness is made rougher continuously or stepwise from the central portion of the Fresnel lens sheet outwardly in a horizontal direction.

7. A Fresnel lens sheet according to claim 1, characterized in that a lens shape for diffusing incident light in a vertical direction is formed on the sheet surface on which no Fresnel lens element group is formed.

8. A rear projection type screen characterized by comprising: a Fresnel lens sheet according to claim 1; and a lenticular lens sheet for diffusing light having passed through the Fresnel lens sheet.
